(19) United States
(12) Patent Application Publication
(10) Pub. No.: US 2023/0208340 A1
(43) Pub. Date: Jun. 29, 2023

(54) METHOD FOR OPERATING AN INVERTER CONNECTED TO AN ELECTRIC MACHINE USING A CONTROL DEVICE AND ELECTRICAL CIRCUIT ASSEMBLY

(71) Applicant: Schaeffler Technologies AG & Co. KG, Herzogenaurach (DE)

(72) Inventor: Andreas Humbert, Ottersweier (DE)

(73) Assignee: Schaeffler Technologies AG & Co. KG, Herzogenaurach (DE)

(21) Appl. No.: 17/927,383

(22) PCT Filed: May 18, 2021
(86) PCT No.: PCT/DE2021/100437

§ 371 Date: Nov. 23, 2022

(30) Foreign Application Priority Data
May 29, 2020 (DE) 10 2020 114 440.7

(51) Int. Cl. H02P 27/14; H02P 27/08; H02P 21/05

(52) U.S. Cl. CPC H02P 27/14; H02P 27/085; H02P 21/05

(57) ABSTRACT

A method is provided for operating a multi-phase inverter connected to an electric machine using a control device, wherein the inverter comprises a plurality of switch devices and the control device controls the inverter to adjust a control variable by means of space vector modulation. The method includes providing a number of possible space vectors for representing the control variable according to a number of phases of the inverter. The method further includes assigning each possible space vector a disturbance variable in the electric machine occurring in a switching state of the switch devices of the inverter described by the respective space vector. The method further includes selecting one or more control space vectors according to the control variable from the number of possible space vectors for representing the control variable. The selected one or more control space vectors represent control variable and have the respective smallest associated disturbance variable of the possible space vectors.

### CROSS-REFERENCE TO RELATED APPLICATIONS

This application is the U.S. National Phase of PCT Appln. No. PCT/DE2021/100437 filed May 18, 2021, which claims priority to DE 102020114440.7 filed May 29, 2020, the entire disclosures of which are incorporated by reference herein.

### TECHNICAL FIELD

The disclosure relates to a method for operating a multi-phase inverter connected to an electric machine using a control device, wherein the inverter comprises a plurality of switch devices and the control device controls the inverter to adjust a control variable by means of space vector modulation, wherein a number of possible space vectors for representing the control variable are provided according to the number of phases of the inverter.

### BACKGROUND

When an electric machine is operated via an inverter, for example a three-phase pulse inverter, disturbance voltages can arise in a neutral point of the electric machine due to the pulse pattern used when the inverter is operated. These disturbance voltages, also referred to as common-mode voltages, are undesirable since they can lead to problems during operation of the electric machine. On the one hand, such disturbance voltages can have a problematic effect on the electromagnetic compatibility of the electric machine or the electrical circuit connected to the electric machine, and on the other hand, capacitive currents can be generated by these voltages, in particular by a voltage edge with which these voltages rise, which negatively influence the service life of the mechanical components of the electric machine and/or other components connected to the electric machine, such as bearings or gears.

Measures such as the use of sacrificial bearings and/or shaft grounding can be provided to compensate for the effects caused by the disturbance voltages. However, these increase the manufacturing complexity of the electric machine, so that it is desirable to prevent or at least reduce the occurrence of the disturbance variables, so that fewer or no measures to compensate for the effect of these disturbance voltages are necessary.

### SUMMARY

The present disclosure, according to an exemplary embodiment, specifies an improved method for operating a multi-phase inverter connected to an electric machine using a control device, which method reduces or prevents faults that occur in particular when the electric machine is operating.

The disclosed method provides that each possible space vector is assigned a disturbance variable in the electric machine occurring in a switching state of the switch devices of the inverter described by the respective space vector, wherein one or more control space vectors are selected according to the control variable from the number of possible space vectors for representing the control variable, which allow for the representation of the control variable and which have the respective smallest assigned disturbance variable in terms of absolute value of the space vectors allowing for the representation of the control variable.

The space vectors available for representing the control variable each describe a switching state of the switch devices of the inverter. The switch devices can, in particular, be half-bridges, which are each formed by two switching elements, in particular by two transistors. The switch devices can assume different switching states, which result from the respective switching states (open or closed) of the switching elements of the switch devices. For example, a first switching state in which a high-side transistor is open and a low-side transistor is closed and a second switching state in which the high-side transistor is closed and the low-side transistor is open can be used in a switch device designed as a half-bridge. Correspondingly, the switching states of the switch devices result from the possible combinations of the switching states of the individual switch devices.

A disturbance variable, which occurs in the corresponding switching state of the switch devices in the electric machine, can be assigned to each of these switching states described by the space vectors. According to the present disclosure, a voltage at a neutral point of the electric machine can be used as the disturbance variable, which voltage occurs in the switching state of the switch devices of the inverter assigned to the respective space vector. The absolute value of such a voltage is not the same for every switching state, but can differ for different switching states. The disturbance variables that arise in each case can be assigned to the space vectors that are available depending on the number of phases of the inverter, so that it is possible to distinguish between space vectors with disturbance variables that are higher in terms of absolute value and disturbance variables that are smaller in terms of absolute value.

Depending on a predetermined control variable, which is to be adjusted by the inverter, only that portion can be selected from the set of all possible space vectors, which comprises the space vectors with the smallest assigned disturbance variables in terms of absolute value. As a result, depending on the disturbance variables or depending on an operating point described by the control variable, a selection can be made as to which space vector is used to represent the control variable, so that if it allows the representation of the control variable, advantageously only the space vector with the smallest assigned disturbance variables in terms of absolute value can be used to represent the control variable.

This has the advantage that, at least in those cases in which the control variable can be represented by a control space vector with an assigned disturbance variable that is comparatively small in terms of absolute value, in particular the assigned disturbance variable that is the smallest in terms of absolute value, the disturbance variable occurring in the electric machine can also be reduced or eliminated. This distinction, which is dependent on the control variable or the operating point, makes it possible not to use space vectors with a high assigned disturbance variable in terms of absolute value to represent the control variable if the control variable can also be represented with one or more space vectors to which a smaller disturbance variable in terms of absolute value is assigned.

The reduction of a disturbance variable, for example as a voltage in a neutral point of the electric machine, for at least some of the control variables or for some of the operating points of the electric machine, has an advantageous effect on the service life of components of the electric machine affected by the disturbance variable, for example bearings of the electric machine and/or other components connected to the electric machine, such as gears or the like. To control the inverter, the control device can comprise a driver circuit or can be connected to a driver circuit connected to the inverter, so that the inverter can be operated by the control device.

According to the present disclosure, it can be provided that the control space vectors are selected in such a way that at least two of the control space vectors can each be converted into at least one other of the control space vectors by changing a switching state of one of the switch devices of the inverter. This has the advantage that the switching losses during operation of the inverter can be reduced since only one of the switching elements of the inverter has to be operated in each case for the space vector modulation of the control variable or for adjusting the control space vectors used for this purpose. The control space vectors, which can each be converted into at least one other control space vector by changing a switching state of one of the switch devices of the inverter, can in particular be space vectors that differ from a zero vector. The control space vectors used to represent the control variable can preferably be adjusted in a sequence that enables a change between the control space vectors by switching a single switch device of the inverter. A zero vector, which may be required to adjust an absolute value of the control variable, can additionally be selected as a control space vector in such a way that as few switch devices as possible have to change their switching state to adjust the control variable.

According to the present disclosure, it can be provided that the control variable is assigned to a sector depending on an absolute value and a phase of the control variable, wherein the sector is formed by space vectors with the small disturbance variable in terms of absolute value, wherein the space vectors forming the sector assigned to the control variable are used as control space vectors for representing the control variable. The absolute value and the phase of the control variable can result, for example, in the case of an electric machine used as a drive motor, from the absolute value and the phase position of an alternating current generated by the inverter for operating the electric machine. In this case, for example, the phase of the control variable can be specified by the angle of a rotor position sensor, which determines the position of a rotor of the electric machine. The absolute value of the control variable can result, for example, from the absolute value of an engine power requirement, for example, when using the electric machine as a traction electric motor in a motor vehicle, from the position of an accelerator pedal or the like. These specifications can be transmitted to the control device, which determines the control variable from these specifications and controls the inverter to adjust the control variable.

In order to enable the control variable to be adjusted by means of space vector modulation, the control device can assign the control variable to a sector, wherein the space vectors forming the sector are used to represent the control variable. In particular, the sectors can advantageously be considered that are formed by the space vectors with the smallest disturbance variables in terms of absolute value, so that the space vectors with the smallest assigned disturbance variable in terms of absolute value can be used to represent the control variable. The sectors to be used depending on the control variable can be stored in the control device, so that the control variable can be efficiently assigned to a sector.

The sectors can each be formed at least partially by space vectors, which differ only by a switching position of a switch device of the inverter, so that only the lowest possible switching losses occur when representing the control variable. Sectors for representing disturbance variables, which have a lower absolute value, can in particular also comprise a zero vector. In this way, possible space vectors, which in principle enable the disturbance variable to be represented, but have a high assigned disturbance variable in terms of absolute value, can advantageously remain unconsidered if the disturbance variable can also be represented by control space vectors with smaller assigned disturbance variables in terms of absolute value.

According to the present disclosure, it can be provided that the inverter comprises more than three phases. The inverter can in particular comprise one switch device per phase, so that using an inverter with more than three phases has the advantage that the number of possible space vectors increases due to the number of switching states of the switch devices also increasing with the number of phases. In addition, it is possible that the respective smallest disturbance variable in terms of absolute value decreases with an increasing number of phases, so that the use of an inverter with more than three phases can lead to the generation of a disturbance variable that is lower in terms of absolute value. In order not to excessively increase the complexity of implementing the inverter and/or a driver circuit operated by the control device, for example, which is connected to the inverter, it can be provided that the number of phases of the inverter is 50 or fewer, in particular 10 or less, for example five, six or seven. An increase in the number of phases does not necessarily have to lead to an increase in the overall size of the inverter, since the switch devices of the same size only have to carry lower overall phase currents to operate the electric machine due to the phases connected in parallel. Correspondingly, a driver circuit which also comprises more than three drivers for the switch devices of the inverter for more than three phases can be designed for lower powers in each case.

In an exemplary embodiment of the present disclosure, it can be provided that an inverter is used, which has an odd number of phases, wherein the number is greater than three and is in particular a prime number. This has the advantage that the disturbance voltage, which is in each case applied to the space vector with the smallest disturbance voltage, is lower than in a three-phase system, as a result of which overall lower disturbance voltages can be brought about in the electric machine. Furthermore, there are also more space vectors available, each of which is assigned the smallest disturbance variable in terms of absolute value, so that overall a representation of the control variable with control space vectors, which each have the smallest assigned disturbance variable in terms of absolute value, for a larger number of different control variables or for a larger number of different operating points is possible.

Due to more space vectors with the smallest assigned disturbance variables in terms of absolute value being available, it is possible for a system made up of an inverter and an electric machine, which has more than three phases, to also map control variables or operating points in the range of lower powers using the space vectors with the smallest assigned disturbance variable in terms of absolute value. The modulation factor of the system is improved by the higher number of available space vectors. An advantageous consequence of this is lower phase currents in the inverter, which allow lower ohmic losses and thus higher performance of the inverter or the electric machine with the same supply voltage.

According to the present disclosure, it can be provided that an inverter is used, which has an even number of phases, wherein the number is greater than three. In such a system, advantageously, zero vectors with small disturbance variables in terms of absolute value are available, in particular zero vectors in which no disturbance variable occurs or in which the absolute value of the disturbance variable is zero. In multi-phase, even-numbered systems, these are those zero vectors whose switching states describe exactly the same number of complementary switching states of the switch devices of the inverter, i.e., those zero vectors that comprise the same number of zeros and ones in a binary representation of the switching states of the switch devices. In even-numbered systems with more than three phases, these are available in addition to the zero vectors, which comprise only zeros or only ones or only the same switching states of the switch devices of the inverter.

According to the present disclosure, if at least one zero vector is possible and/or required to represent the control variable, a zero vector from a set of possible zero vectors is used as at least one control space vector, to which the smallest disturbance variable is assigned. In this regard, a small disturbance variable in terms of absolute value can be assigned to the zero vector, or it can be a zero vector to which no disturbance variable or a disturbance variable with an absolute value of zero is assigned. A zero vector to which a disturbance variable with an absolute value of zero is assigned can also be used if the control variable can be represented by this zero vector, since it has the advantage compared to the other available space vectors, which each have a smallest possible disturbance variable that is, however, greater than zero, that no disturbance variable is generated by the switching state of the switch devices assigned to this zero vector.

According to the present disclosure, it can be provided that a voltage at a neutral point of the electric machine is used as the disturbance variable, which voltage occurs in the switching state of the inverter assigned to the respective space vector. These disturbance voltages, also referred to as common-mode voltage, can be calculated for the various switching states of the switch devices of the inverter depending on the number of phases of the inverter and/or determined by measurement, so that these voltages can be assigned to the individual switching states or to the space vectors describing one of the switching states in each case. Additionally or alternatively to the common-mode voltage, it is also possible to use another disturbance variable in the electric machine, which is generated with different absolute values for different space vectors or different switching states of the switch devices of the inverter.

In an exemplary embodiment of the present disclosure, it can be provided that an inverter is used, which comprises switch devices with switching elements made of silicon carbide. Such an inverter with switching elements made of silicon carbide can be operated with particular advantage using the method according to the present disclosure, since due to the high operating voltages that can be used with switching elements made of silicon carbide, particularly large disturbance variables, in particular particularly large common-mode voltages at a neutral point of the electric machine, can occur. These can be reduced and/or avoided with the aid of the method according to the present disclosure, so that the high operating voltages and the high switching speeds of the switching elements made of silicon carbide can be advantageously utilized.

According to the present disclosure, it can be provided that a multi-phase alternating current or a multi-phase alternating voltage is used as the control variable to operate the electric machine, wherein the number of phases of the alternating current or the alternating voltage corresponds to the number of phases of the inverter.

Provision is made for an electrical circuit assembly according to the present disclosure that it comprises a control device, a multi-phase inverter circuit and an electric machine, wherein the control device is configured to carry out a method according to the present disclosure. The electric machine can be designed in particular for use as a traction electric motor for a motor vehicle. The electrical circuit assembly makes it possible to operate the electric machine in a driving operation of a motor vehicle comprising the electric machine.

All the advantages and embodiments described above in relation to the method according to the present disclosure also apply correspondingly to the electrical circuit assembly according to the present disclosure.

### BRIEF DESCRIPTION OF THE DRAWINGS

The present disclosure is explained below using exemplary embodiments with reference to the drawings. The drawings are schematic representations and show the following:

FIG. 1 shows an exemplary embodiment of a circuit assembly according to the present disclosure,

FIG. 2 shows a first diagram for explaining a first exemplary embodiment of the method according to the present disclosure,

FIG. 3 shows a second diagram for explaining a second exemplary embodiment of the method according to the present disclosure,

FIG. 4 shows a third diagram for explaining a third exemplary embodiment of the method according to the present disclosure,

FIG. 5 shows a fourth diagram for explaining a fourth exemplary embodiment of the method according to the present disclosure, and

FIG. 6 shows a fifth diagram for explaining a fifth exemplary embodiment of the method according to the present disclosure.

### DETAILED DESCRIPTION

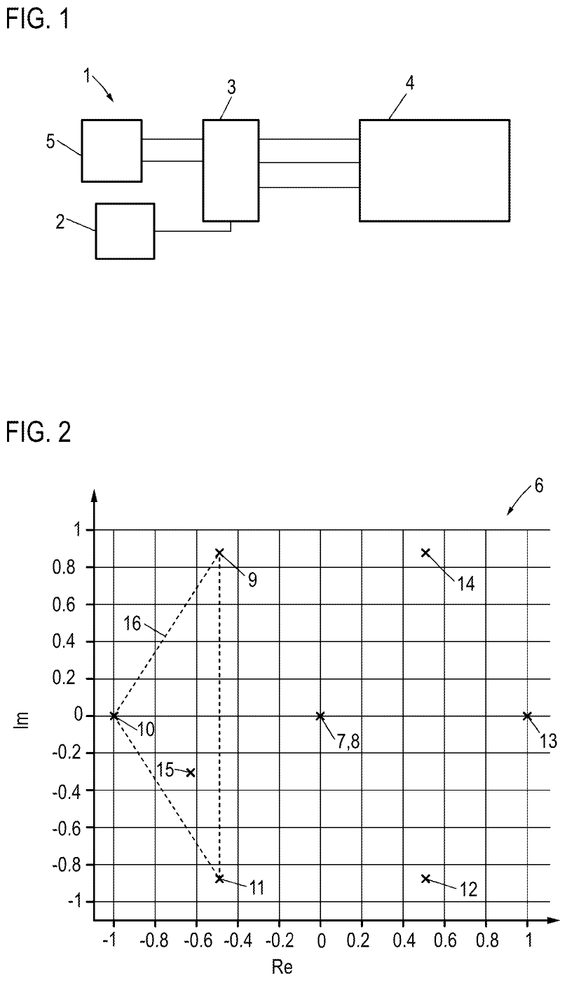

FIG. 1 shows an electrical circuit assembly 1 according to the present disclosure. The electrical circuit assembly 1 comprises a control device 2, a multi-phase inverter 3 and an electric machine 4, which is connected to the inverter 3. The inverter 3 comprises a plurality of half-bridges as switch devices, each of which is formed from two switching elements, wherein the inverter 3 in the present exemplary embodiment comprises three half-bridges and thus three switch devices with a total of six switching elements, and is therefore designed as a three-phase pulse inverter. Accordingly, the electric machine 4 is also designed as a three-phase electric machine 4, wherein the three-phase inverter 3 and the three-phase electric machine 4 form a three-phase system. It is possible for the inverter 3 to have more than three phases, so that the inverter 3 also comprises more than three half-bridges and thus also more than three switch devices and more than six switching elements. In such a case, the electric machine 4 also has more than three phases corresponding to the inverter 3, wherein the inverter 3 and the electric machine 4 form a system with the corresponding number of phases.

The inverter 3 is connected to a direct current source 5, for example, a battery or the like, and is used to convert the direct current already provided by the direct current source 5 into alternating current for operating the electric machine 4. The direct current can, for example, be provided by the direct current source 5 with a voltage between 400 V and 800 V. The electric machine 4 can be designed in particular for use as a traction electric motor for a motor vehicle. The electrical circuit assembly 1 can thus enable operation of the electric machine 4 in a driving operation of a motor vehicle comprising the electric machine 4.

To this end, the inverter 3 is operated by the control device 2. For this purpose, the control device 2 can comprise a driver circuit or can be connected to a driver circuit (not shown) connected to the inverter 3. A control variable to be adjusted by the inverter 3 can be determined by the control device 2 itself or can be transmitted to the control device 2 by a further control device (not shown). A control variable to be adjusted via the inverter 3 can be composed, for example, of an absolute value of a motor power requirement that describes a power that is to be provided with the electric machine 4 and an angle that corresponds to an angle of a rotor of the electric machine 4. The angle of the rotor of the electric machine 4 can be determined, for example, by an angular position sensor (not shown) of the electric machine 4 and can be transmitted to the control device 2.

The control device 2 is designed to control the inverter 3 to adjust the control variable by means of space vector modulation. The space vector modulation is based on a set of space vectors, which describe the possible switching positions of the switch devices or the half-bridges of the inverter 3. The absolute value of a disturbance variable that occurs in the electric machine 4 is assigned to each of these switching states. In this case, a disturbance voltage which is produced at a neutral point of the electric machine 4 and is also referred to as a common-mode voltage can, in particular, be used as the disturbance variable. This can have different signs and, in particular, different absolute values for different switching states of the switch devices of the inverter 3 or for different space vectors possible for space vector modulation.

The common-mode voltage U_{CM} is shown in Table 1 as an example for a three-phase inverter 3, wherein two different switching positions of the switching elements are possible for the three half-bridges of the three-phase inverter 3. The switching positions of switch devices S1-S3 are denoted in Table 1 as 0 and 1, respectively. The disturbance voltage U_{CM} generated in the respective switching states of the inverter 3, which result from the various possible combinations of the switching states of the switching elements S1-S3, is also given in Table 1. As can be seen, the absolute value of the disturbance voltage U_{CM} for the respective switching states corresponding to a zero vector (S1=S2=S3=0 and S1=S2=S3=1) is U_DC/2, wherein U_DC is the direct voltage provided by the direct current source 5. In the other switching positions, the absolute value of the disturbance voltage U_{CM} is U_DC/6 in each case.

TABLE 1

| S1 | S2 | S3 | U_{CM} |
|---|---|---|---|
| 0 | 0 | 0 | −U_DC/2 |
| 1 | 0 | 0 | −U_DC/6 |
| 0 | 1 | 0 | −U_DC/6 |
| 1 | 1 | 0 | +U_DC/6 |
| 0 | 0 | 1 | −U_DC/6 |
| 1 | 0 | 1 | +U_DC/6 |
| 0 | 1 | 1 | +U_DC/6 |
| 1 | 1 | 1 | +U_DC/2 |

The possible switching states or the possible space vectors thus clearly comprise space vectors to which a disturbance variable that is higher in absolute value is assigned, and space vectors to which a disturbance variable that is smaller in absolute value is assigned. In addition to the case shown in Table 1 for a three-phase inverter 3, this also applies to inverters 3 that have more than three phases, wherein in such inverters the total number of switching states for n phases of the inverter increases to 2ⁿ switching states due to the additional switch devices present in the inverter.

FIG. 2 describes a first diagram for explaining a first exemplary embodiment of a method according to the present disclosure. In the diagram 6, the real part is plotted on the abscissa and the imaginary part is plotted on the ordinate of the respective space vector represented in a complex manner. For the sake of clarity, only the end points or the peaks of the vectors are shown for the assigned space vectors of the respective resulting switching states for the three-phase inverter 3.

Eight space vectors 7-14 are consequently assigned to the switching states described above in Table 1, wherein the space vectors 7, 8 are zero vectors at the origin of the diagram and the other space vectors 9-14 are arranged in a hexagon around the origin. According to Table 1, the space vectors 9-14 correspond to the space vectors to which the smallest disturbance variable U_{CM} is assigned in terms of absolute value. Depending on a control variable 15 to be adjusted by way of example, of which vector only the peak vector is also shown, those space vectors 7-14 can now be selected as control space vectors from the total possible space vectors 9-14 available for representing the control variable 15, which enable representation of the control variable 15 and in each case have the smallest assigned disturbance variable in terms of absolute value.

For the example of the control variable 15 described in FIG. 2, the space vectors 9-11 can be used as control space vectors to represent the control variable 15. For this purpose, the control device 2 can assign the control variable 15 to a sector 16 depending on an absolute value and a phase of the control variable 15, i.e., the position of the control variable 15 in diagram 6, wherein the sector 16 is formed by the space vectors 9-11 as shown and the control variable 15 is within the sector 16. This can also be done accordingly for the other space vectors 12-14 and for the other sectors, which can each be formed from, for example, three of the space vectors 9-14, in cases in which a representation of the control variable 15 is possible by another combination of the space vectors 9-14, thus by the space vectors in each case with the smallest assigned disturbance variable in terms of absolute value. Which of the space vectors 7-14 can be used to represent the control variable 15 depends on the absolute value and the phase of the control variable 15, i.e., on the position of the tip of the space vector describing the control variable 15 in diagram 6.

Depending on the control variable or an operating point described by the control variable 15, the control device 2 thus selects the space vectors 7-14 which are used to represent the disturbance variable, wherein of all possible space vectors 7-14 which enable the representation of the control variable 15, those space vectors 7-14 which enable the representation of the control variable 15 and in each case have the smallest assigned disturbance variable in terms of absolute value are used as control space vectors. The sectors to be used for this can be stored in the control device 2, for example, so that the control variable 15 can be easily assigned to one of the sectors and thus to three of the space vectors 7-14, for example.

Furthermore, the control space vectors 9-11 or the sector 16 are selected in such a way that at least two of the control space vectors 9-11 can each be converted into at least one other of the control space vectors 9-11 by changing a switching state of one of the switch devices of the inverter 3. This makes it possible to select the sequence of the control space vectors 9-11 by sequentially controlling the inverter 3 according to one of the control space vectors 9-11 to represent the control variable 15 so that only the switching state of one of the switching elements has to be changed in order to move from one control space vector to the next. This has the advantageous effect that the switching losses in the switch devices are reduced when the control variable 15 is adjusted.

As can be seen from the diagram 6, one of the zero vectors 7, 8 must be used to represent the control variable 15 for control variables 15 which have a smaller absolute value and are therefore outside the sector 16 shown as an example and are closer to the origin. As a result, in the three-phase system described, the disturbance variable U_{CM} can only be reduced if a control variable 15 is adjusted, which can only be represented by one or more of the space vectors 9-14. Nevertheless, the use of the space vectors 9-14 with the smallest assigned disturbance variables U_{CM} in terms of absolute value in the part of the operating points in which a representation of the control variable 15 by the space vectors 9-14 with the smallest assigned disturbance variables in terms of absolute value is possible, results in a reduction of a load on the electric machine 4 and/or components connected to the electric machine 4.

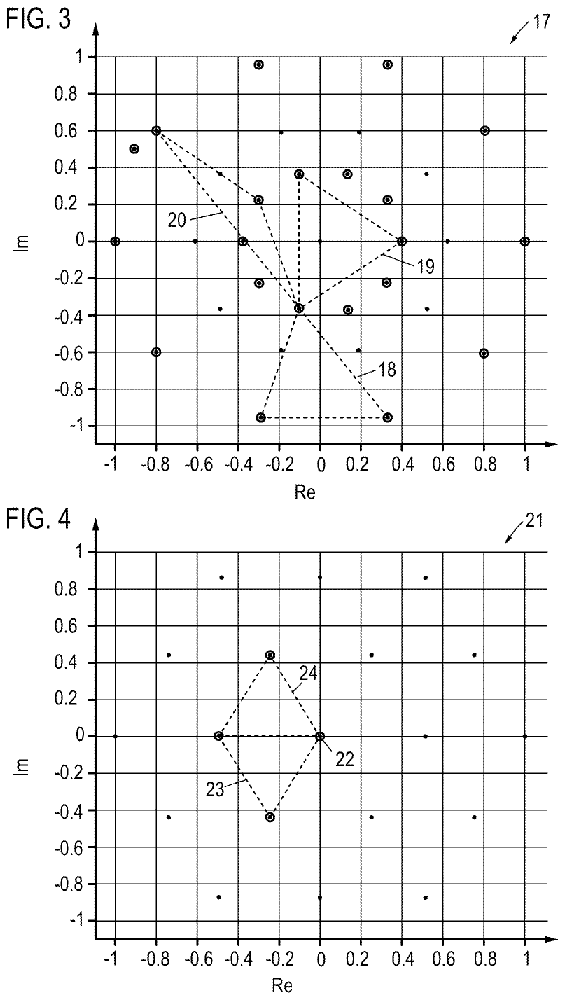

FIG. 3 shows a second diagram 17, in which the real part is also shown on the abscissa and the imaginary part is shown on the ordinate. Corresponding to the diagram 6 in FIG. 2, only the point of the tip of the space vector is shown in diagram 17 for the various space vectors for the sake of clarity. All possible space vectors that result for an inverter 3 with five phases are plotted as points in diagram 17. In a five-phase configuration, the inverter 3 comprises five switch devices, designed as half-bridges, for example, resulting in a total of 32 different combinations of switching states of the switch devices. Correspondingly, in the diagram 17 the peaks of the 32 possible space vectors corresponding to the switching states are shown.

The space vectors additionally provided with a circle correspond to the space vectors for which the minimum absolute value of a common-mode voltage results. For the marked space vectors, this is +/−0.1*U_DC and is therefore lower than in the three-phase system described above. The boundary condition of the smallest possible disturbance variable in terms of absolute value means that the zero vectors, at which a higher disturbance variable is generated, are not used to represent the control variable.

Three sectors 18, 19, 20 are shown by way of example, each of which is formed from three of the space vectors with the respective smallest assigned disturbance variable in terms of absolute value. Furthermore, the space vectors forming the sectors 18, 19, 20 shown make it possible to convert at least two of the space vectors into another of the space vectors by changing a switching state of one of the switch devices of the inverter 3. For a control variable to be adjusted, the control device 2 can determine in which of the existing sectors 18, 19, 20 the control variable falls, wherein the space vectors forming the sector 18, 19, 20 are then used to adjust the control variable. The sectors 18, 19, 20 shown are selected purely by way of example from the set of sectors resulting overall from the space vectors with the lowest assigned disturbance variable in terms of absolute value. The space vectors forming the respective sectors 18, 19, 20 are selected such that at least two of the space vectors can be converted into at least one of the other space vectors by changing a switching state of one of the switching elements of the inverter 3. When these space vectors are used as control space vectors, this advantageously contributes to reducing switching losses, since only one of the switching elements has to be operated for space vector modulation in order to switch between the control space vectors used to represent the control variable.

If there are several sectors in which the control variable falls, one of the sectors can be selected, for example, by means of an assignment specification, which is stored in the control device 2, and the corresponding space vector can be used to adjust the control variable. As can be seen, the use of a five-phase inverter 3 makes it possible to adjust control variables with a small absolute value, for example through the sector 19, even without using a zero vector.

FIG. 4 shows a diagram 21, in which the real part is shown on the ordinate and the imaginary part is shown on the abscissa, and in which the peaks of the space vectors are shown as points, each of which has the smallest assigned disturbance variable in terms of absolute value for a six-phase inverter 3. In the case of the six-phase inverter 3 shown in diagram 21, this is an absolute value of U_DC/6 for the common-mode voltage U_{CM}. In addition, the six-phase inverter 3 also makes it possible to use the zero vector 22, since in the six-phase system made up of the six-phase inverter 3 and the six-phase electric machine 4, in addition to the switching states in which all switch devices each have the same switching state, further zero vectors 22 are available, which comprise the same number of complementary switching states, i.e. the same number of 0s or 1s as shown in Table 1. These zero vectors 22 advantageously have an assigned disturbance variable with an absolute value of zero, since no disturbance variable U_{CM} is generated in the electric machine 4 in the corresponding switching states of the switch devices of the inverter 3.

Two sectors 23, 24 are shown by way of example, which, in addition to a zero vector 22, also have two further space vectors with the smallest assigned disturbance variable in terms of absolute value. A control variable within one of the respective triangular sectors 23, 24 can be adjusted accordingly by the space vector delimiting the sector 23, 24 and the zero vector 22, wherein the zero vector 22 is used as the zero vector with no or the smallest assigned disturbance variable in terms of absolute value. Correspondingly, control variables with a larger absolute value, which lie outside of the two sectors 23, 24 shown by way of example, can be represented by sectors or control space vectors, which do not comprise the zero vector 22. In this way, it is possible to represent all possible control variables by space vectors, which each have the smallest assigned disturbance variable in terms of absolute value. The disturbance variables that occur overall in the electric machine 4 can thus advantageously be reduced.

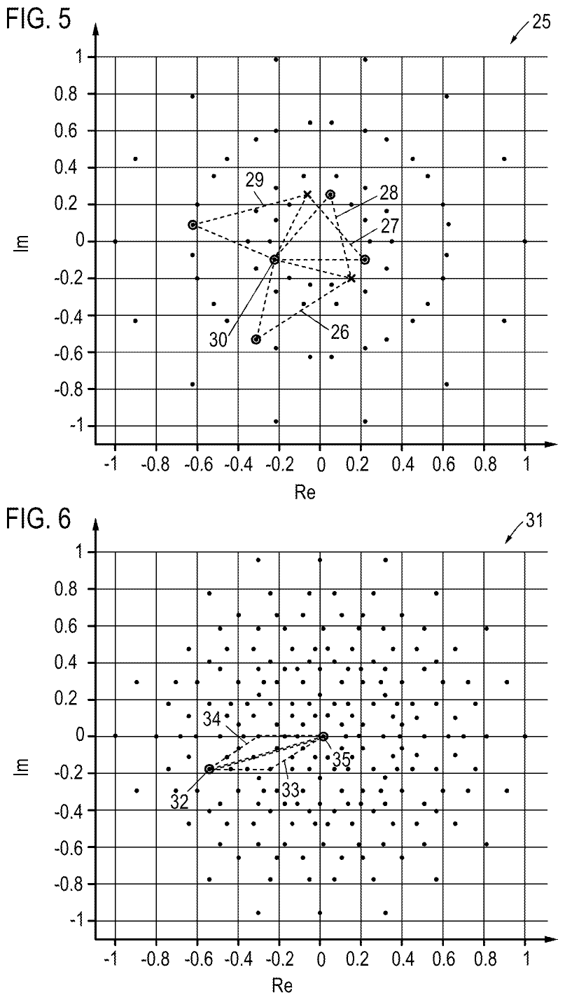

In addition to the examples with five phases and six phases described above, it is also possible to extend the method to a system with a larger number of phases. FIG. 5 shows an example of a seven-phase system in a diagram 25, in which different sectors 26-29 are available in the range of control variables with small absolute values in order to adjust the control variable, wherein the sectors each comprise a space vector 30. The space vectors of the sectors 26-29 shown can be converted into one another by changing a switching state of one of the switch devices, wherein it is possible to represent small control variables in terms of absolute value even without the presence of a zero vector.

When representing control variables with larger absolute values, sectors can correspondingly also be used which comprise one or more of the space vectors that lie on the outer circle, so that a larger absolute value of the control variable can be represented. The use of a seven-phase system has the advantage that the absolute value of the common-mode voltage U_{CM} of the space vectors shown as points in diagram 25 drops to 1/14*U_DC in each case, so that compared to the three-phase system described in relation to FIG. 2, a reduction in the occurring common-mode voltage U_{CM} by a factor greater than two is possible. Due to the higher number of space vectors with an absolute value of one, i.e., due to the higher number of space vectors lying on the outer circle around the origin, better utilization of the direct voltage U_DC provided by the direct current source 5 can be achieved.

In principle, in addition to the seven-phase system, systems with an even larger number n of phases can also be used, wherein for the common-mode voltage U_{CM} a lowest absolute value of U_{CM}=0.5*U_DC*(1/n) results in each case for a part of the space vectors, wherein this concerns space vectors which are different from a zero vector for an odd value of n in each case. With an even value for n, zero vectors are present in each case in accordance with the example for a six-phase system from diagram 21 in FIG. 4, for which the common-mode voltage U_{CM} has an absolute value of zero. If this is possible or necessary for representing the control variable, these zero vectors can be used together with the space vectors, which are different from the zero vectors and each have the smallest disturbance variable U_{CM} in terms of absolute value.

In a diagram 31 in FIG. 6, the space vectors in a ten-phase system are shown by way of example, which of the 1024 possible space vectors each have the smallest assigned disturbance variable U_{CM} in terms of absolute value. Starting from a space vector 32, two different sectors 33, 34 are shown as an example, wherein control variables lying within the respective sectors 33, 34 are able to be represented by the space vectors delimiting the respective sectors 33, 34 and the zero vector 35. Since zero vectors 35 are also present in ten phases, in each of which no disturbance voltage U_{CM} occurs in the electric machine 4, these zero vectors 35 can preferably be used to represent the control variable.

In all the diagrams described above, the sectors or space vectors shown for representing the control variable are only an exemplary selection from the sectors or space vectors, which can be used to represent the control variable and which in each case have both a disturbance variable that is the smallest in terms of absolute value and also enable at least two of the space vectors to be converted into one of the space vectors in each case by changing the switching state of only one of the switch devices of the inverter 3. Depending on the absolute value and phase of the control variable, there are also other sectors, not shown, from the space vectors shown with the smallest assigned disturbance variable in terms of absolute value, which can be converted at least partially into another of the space vectors by changing just one switching state of a switch device of the inverter 3 and which enable a representation of the corresponding control variable. It is also possible for sectors to be used which are formed from a number other than three space vectors, wherein a representation of the control variable with the number of space vectors different from three takes place accordingly.

In the case of an electric machine 4 used as a traction electric motor, for example, the number of phases of the system consisting of the inverter 3 and the electric machine 4 can be selected from the distribution of the operating points or control variables to be expected when a motor vehicle containing the electric machine 4 is in operation, so that the electrical circuit 1 is adapted as well as possible to the operating conditions to be expected.

The switch devices of the inverter 3, which are designed in particular as a half-bridge, preferably comprise switching elements, for example bipolar transistors with an insulating gate (IGBTs) or metal-oxide-semiconductor field-effect transistors (MOSFETs), made of silicon carbide, so that a high switching speed of the switching elements and thus also of the switch devices or the inverter 3 is made possible. The reduction of a common-mode voltage at the neutral point of the electric machine 4 achieved by the selection of the space vectors according to the present disclosure enables higher operating voltages as well as a reduction of negative effects due to the disturbance variable even at high switching speeds or steeper switching edges, which leads, for example, to an improved electromagnetic compatibility (EMC) of the electrical circuit assembly 1.

Additionally or alternatively to the common-mode voltage U_{CM}, it is also possible to use another disturbance variable in the electric machine 4, which is generated with different absolute values for different space vectors or different switching states of the switch devices of the inverter 3.

### LIST OF REFERENCE NUMERALS

TABLE 1

| | |
|---|---|
| 1 | Electrical circuit assembly |
| 2 | Control device |
| 3 | Inverter |
| 4 | Electric machine |
| 5 | Direct current source |
| 6 | Diagram |
| 7 | Space vector |
| 8 | Space vector |
| 9 | Space vector |
| 10 | Space vector |
| 11 | Space vector |
| 12 | Space vector |
| 13 | Space vector |
| 14 | Space vector |
| 15 | Control variable |
| 16 | Sector |
| 17 | Diagram |
| 18 | Sector |
| 19 | Sector |
| 20 | Sector |
| 21 | Diagram |
| 22 | Zero vector |
| 23 | Sector |
| 24 | Sector |
| 25 | Space vector |
| 26 | Sector |
| 27 | Sector |
| 28 | Sector |
| 29 | Sector |
| 30 | Space vector |
| 31 | Diagram |
| 32 | Space vector |
| 33 | Sector |
| 34 | Sector |
| 35 | Zero vector |
| S1 | Switching position of |
| | the switching elements |
| S2 | Switching position of |
| | the switching elements |
| S3 | Switching position of |
| | the switching elements |

1. A method for operating a multi-phase inverter connected to an electric machine using a control device, the inverter comprising a plurality of switch devices and the control device configured to control the inverter to adjust a control variable via space vector modulation, the method comprising:
providing a number of possible space vectors for representing the control variable according to a number of phases of the inverter;
assigning each possible space vector a disturbance variable in the electric machine occurring in a switching state of the switch devices of the inverter described by the respective space vector; and
selecting one or more control space vectors according to the control variable from the number of possible space vectors for representing the control variable, wherein the selected one or more control space vectors represent the control variable and have the respective smallest associated disturbance variable in terms of absolute value of the possible space vectors.

2. The method according to claim 1, wherein the control space vectors are selected in such a way that at least two of the control space vectors can each be converted into at least one other of the control space vectors by changing a switching state of one of the switch devices of the inverter.

3. The method according to claim 1, further comprising:
assigning the control variable to a sector based on an absolute value and a phase of the control variable, and
selecting the control space vectors forming the sector assigned to the control variable as the control space vectors for representing the control variable, wherein the sector is formed by the possible space vectors with the small disturbance variable in terms of absolute value.

4. The method according to claim 1, wherein the inverter has an odd number of phases, wherein the number is greater than three and is a prime number.

5. The method according to claim 1, wherein the inverter has an even number of phases, wherein the number is greater than three.

6. The method according to claim 5, wherein a zero vector from a set of possible zero vectors is selected as at least one control space vector if at least one of the possible zero vectors represents the control variable, wherein the smallest disturbance variable is assigned to the selected zero vector.

7. The method according to claim 1, wherein a voltage at a neutral point of the electric machine is the disturbance variable, the voltage occurs in the switching state of the switch devices of the inverter assigned to the respective space vector.

8. The method according to claim 1, wherein the switch devices have switching elements made of silicon carbide.

9. The method according to claim 1, wherein the control variable to operate the electric machine is one of a multi-phase alternating current or a multi-phase alternating voltage, wherein a number of phases of the alternating current or the alternating voltage corresponds to the number of phases of the inverter.

10. An electrical circuit assembly comprising:
an electric machine,
a multi-phase inverter circuit including a plurality of switch devices, and
a control device in communication with the inverter circuit, the control device being configured to:
provide a number of possible space vectors for representing a control variable according to a number of phases of the inverter circuit;
assign each possible space vector a disturbance variable in the electric machine occurring in a switching state of the switch devices of the inverter circuit described by the respective space vector;
select one or more control space vectors according to the control variable from the number of possible space vectors for representing the control variable, wherein the selected one or more control space vectors represent the control variable and have the respective smallest associated disturbance variable in terms of absolute value of the possible space vectors, and
control the inverter circuit to adjust the control variable based on the one or more selected control space vectors.

11. The electrical circuit assembly of claim 10, wherein the control space vectors are selected in such a way that at least two of the control space vectors can each be converted into at least one other of the control space vectors by changing a switching state of one of the switch devices of the inverter circuit.

12. The electrical circuit assembly of claim 10, wherein the control device is further configured to:
assign the control variable to a sector based on an absolute value and a phase of the control variable; and
select the control space vectors forming the sector assigned to the control variable as the control space vectors for representing the control, wherein the sector is formed by the possible space vectors with the small disturbance variable in terms of absolute value.

13. The electrical circuit assembly of claim 10, wherein the inverter circuit has an odd number of phases, wherein the number is greater than three and is a prime number.

14. The electrical circuit assembly of claim 10, wherein the inverter circuit has an even number of phases, wherein the number is greater than three.

15. The electrical circuit assembly of claim 14, wherein a zero vector from a set of possible zero vectors is selected as at least one control space vector if at least one of the possible zero vectors represents the control variable, wherein the smallest disturbance variable is assigned to the selected zero vector.

16. The electrical circuit assembly of claim 10, wherein a voltage at a neutral point of the electric machine is the disturbance variable, the voltage occurs in the switching state of the switch devices of the inverter circuit assigned to the respective space vector.

17. The electrical circuit assembly of claim 10, wherein the switch devices have switching elements made of silicon carbide.

18. The electrical circuit assembly of claim 10, wherein the control variable to operate the electric machine is one of a multi-phase alternating current or a multi-phase alternating voltage, wherein a number of phases of the alternating current or the alternating voltage corresponds to the number of phases of the inverter circuit.

19. The method according to claim 3, further comprising:
determining the absolute value of the control variable based on an engine power requirement; and
determining the phase of the control variable based on a position of a rotor of the electric machine.

20. The electrical circuit assembly of claim 12, wherein the control device is further configured to:
determine the absolute value of the control variable based on an engine power requirement; and
determine the phase of the control variable based on a position of a rotor of the electric machine.
